(19) United States
(12) Patent Application Publication
(10) Pub. No.: US 2016/0004829 A1
(43) Pub. Date: Jan. 7, 2016

(54) CLINICAL LABORATORY DECISION SUPPORT SYSTEM

(71) Applicant: Safedin Beqaj, Irvine, CA (US)

(72) Inventor: Safedin Beqaj, Irvine, CA (US)

(73) Assignee: CLINICAL LAB CONSULTING, LLP, Irvine, CA (US)

(21) Appl. No.: 14/788,877

(22) Filed: Jul. 1, 2015

Related U.S. Application Data
(60) Provisional application No. 62/020,489, filed on Jul. 3, 2014.

(51) Int. Cl. G06F 19/00

(52) U.S. Cl. CPC G06F 19/345

(57) ABSTRACT

A clinical laboratory decision support system and method is disclosed that includes a medical knowledge database, a medical condition input, one or more user-selectable filters, a processor and an output device. The medical knowledge database includes medical tests and relevance information for each of the medical tests. The processor receives the medical condition and the user-selectable filters; accesses and searches the medical knowledge database for applicable tests; and sorts the applicable tests by relevance based on the medical condition, the user-selectable filters and the relevance information for each of the tests. The output device provides a sorted list of applicable tests by relevance as determined by the processor. A hospital interface can be for retrieving patient information, and the patient information can also be used in sorting the applicable tests by relevance. The sorted list of applicable tests can include payment and/or cost information, and visual indicators of relevance.

This application claims priority to U.S. Provisional Patent Application Ser. No. 62/020,489, filed Jul. 3, 2014 entitled “Clinical Laboratory Decision Support System,” the disclosure of which is expressly incorporated herein by reference.

### FIELD OF THE DISCLOSURE

The present disclosure relates to medical system and more particularly to a medical system that aids a practitioner in test selection in order to arrive at a correct diagnosis for a patient more quickly and efficiently.

### BACKGROUND

Arriving at a diagnosis and treatment plan for a patient in the healthcare setting is a multifactorial process that involves clinical assessment, laboratory testing, radiographic testing, achieving a diagnosis, a plan of action and follow up monitoring. To date, all of these processes have been performed by healthcare professionals individually in accordance with the methods learned in training, consultation with colleagues and reference sources and from clinical practice. The practitioner has had to rely upon themselves and their references as the primary knowledge base. Laboratory testing up until the last ten years or so accrued information at a relatively constant rate. However, with the completion of the Human Genome Project and with the advances in computational power, there has been an unprecedented increase in the amount of available information about human disease, its causes, genetic basis and therapeutic options.

The ability of the individual practitioner to maintain currency in all areas of testing is virtually impossible. In order to make a diagnosis, often too many tests are ordered. Even when a diagnosis is suspected or made, the rapid increase in knowledge and available options often means that the practitioner is unaware of tests that could aid in characterization of a disease process or in its therapy and monitoring. Thus it would be desirable to have a system to help guide the practitioner in test selection, both to avoid overuse and underuse of available tests and methodologies, and in the process to educate the practitioner in new tests and methodologies.

### SUMMARY

A clinical laboratory decision support system is disclosed that includes a medical knowledge database, a medical condition input for entering a medical condition, a plurality of user-selectable filters for sorting relevant medical tests, a processor and an output device. The medical knowledge database includes a plurality of medical tests and relevance information for each of the plurality of medical tests. The processor receives the medical condition and the plurality of user-selectable filters; accesses and searches the medical knowledge database for applicable tests from the plurality of medical tests; and sorts the applicable tests by relevance based on the medical condition, the plurality of user-selectable filters and the relevance information for each of the plurality of medical tests. The output device presents the user with a sorted list of applicable tests by relevance as determined by the processor.

The clinical laboratory decision support system can also include a hospital interface for retrieving patient information, and one or more patient identifiers for identifying a specific patient, so that the processor can retrieve patient information through the hospital interface for the specific patient based on the patient identifiers, and also sort the applicable tests by relevance based on the retrieved patient information.

The relevance information for each of the plurality of medical tests can include an indication for testing value, the plurality of user-selectable filters can include an indication for testing filter selection; and the processor can also sort the applicable tests by relevance based on the indication for testing values and the indication for testing filter selection. The relevance information for each of the plurality of medical tests can include a testing discipline value; the plurality of user-selectable filters can include a testing discipline filter selection; and the processor can also sort the applicable tests by relevance based on the testing discipline values and the testing discipline filter selection. The relevance information for each of the plurality of medical tests can include a testing methodology value; the plurality of user-selectable filters can include a testing methodology filter selection; and the processor can also sort the applicable tests by relevance based on the testing methodology values and the testing methodology filter selection. The relevance information for each of the plurality of medical tests can include a pathophysiology value; the plurality of user-selectable filters for ordering relevant medical tests can include a pathophysiology filter selection; and the processor can also sort the applicable tests by relevance based on the pathophysiology values and the pathophysiology filter selection. The relevance information for each of the plurality of medical tests can include a specimen type value; the plurality of user-selectable filters can include a specimen type filter selection; and the processor can also sort the applicable tests by relevance based on the specimen type values and the specimen type filter selection.

The sorted list of applicable tests can include a visual indicator for each of the applicable tests, where the visual indicator for each of the applicable tests indicates a relevancy value for the applicable test. The sorted list of applicable tests can include payment information for each of the applicable tests; where the payment information indicates whether the applicable test is covered by patient insurance. The sorted list of applicable tests can include cost information for each of the applicable tests.

A clinical laboratory decision support method is disclosed that includes accepting a medical condition input; accepting one or more filter values from a plurality of user-selectable filter inputs; searching a medical knowledge database for applicable tests based on the medical condition input and the one or more filter values; sorting the applicable tests by relevance based on the medical condition input, the one or more filter values and the relevance information for each of the applicable tests; and presenting the user with a sorted list of applicable tests by relevance. The medical knowledge database includes a plurality of medical tests and relevance information for each of the plurality of medical tests. The method of claim can also include accepting patient identification information for identifying a specific patient; retrieving patient information from a healthcare database for the specific patient based on the patient identification information; and also sorting the applicable tests by relevance based on the retrieved patient information.

The relevance information for each of the plurality of medical tests can include an indication for testing value; the plurality of user-selectable filters can include an indication for testing filter selection; and the method can include sorting the applicable tests by relevance based on the indication for testing values and the indication for testing filter selection. The relevance information for each of the plurality of medical tests can include a testing discipline value; the plurality of user-selectable filters can include a testing discipline filter selection; and the method can include sorting the applicable tests by relevance based on the testing discipline values and the testing discipline filter selection. The relevance information for each of the plurality of medical tests can include a testing methodology value; the plurality of user-selectable filters can include a testing methodology filter selection; and the method can include sorting the applicable tests by relevance based on the testing methodology values and the testing methodology filter selection. The relevance information for each of the plurality of medical tests can include a pathophysiology value; the plurality of user-selectable filters can include a pathophysiology filter selection; and the method can include sorting the applicable tests by relevance based on the pathophysiology values and the pathophysiology filter selection. The relevance information for each of the plurality of medical tests can include a specimen type value; the plurality of user-selectable filters can include a specimen type filter selection; and the method can include sorting the applicable tests by relevance based on the specimen type values and the specimen type filter selection.

The method can include displaying a visual indicator for each of the applicable tests, where the visual indicator indicates a relevancy value for the applicable test. The method can include accessing payment information for each of the applicable tests; and displaying the payment information for each of the applicable tests, where the payment information indicates whether the applicable test is covered by patient insurance. The method can include accessing cost information for each of the applicable tests; and displaying the cost information for each of the applicable tests.

### BRIEF DESCRIPTION OF THE DRAWINGS

The detailed description refers to the accompanying figures in which:

FIG. 1 illustrates a high-level overview of an exemplary Clinical Laboratory Decision Support System using a computing system;

FIG. 2 shows an exemplary flow diagram for an embodiment of an exemplary Clinical Laboratory Decision Support System;

FIG. 3 shows some exemplary parameter alternatives for an exemplary Clinical Laboratory Decision Support System;

FIG. 4 shows an exemplary weighting scheme in tabular form for testing indications that can be used in a Clinical Laboratory Decision Support System;

FIG. 5 shows the exemplary weighting scheme for testing indications of FIG. 4 in graphical form;

FIG. 6 illustrates an exemplary user interface for a Clinical Laboratory Decision Support System;

FIG. 7 illustrates an alternative exemplary user interface for a Clinical Laboratory Decision Support System; and

FIG. 8 illustrates an alternative exemplary user interface for a searchable electronic medical dictionary in a Clinical Laboratory Decision Support System.

### DETAILED DESCRIPTION

The exemplary embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The Clinical Laboratory Decision Support System (CLDSS) is designed to aid a practitioner in test selection in order to arrive at a correct diagnosis more quickly and with less utilization of resources. There are many thousands of tests available and the number is growing exponentially every year. Many tests can be used in more than one way, such as for both diagnosis and disease monitoring, and some tests have different indications such as screening, routine, diagnostic, confirmatory, disease management and prognostic markers. Simply knowing of a test is not sufficient; the practitioner must know how the test is used and interpreted, and where the test lies in the evaluation process of the patient. Using a test in the proper manner can achieve multiple benefits including quicker diagnosis, reduced use of resources, lower costs, reduced liability for the provider, and a better overall patient outcome and experience. The CLDSS system helps the practitioner know and evaluate the possible tests that can be used in a specific situation, to determine what sequence to utilize the tests, and to determine where the testing decision “branch points” lie.

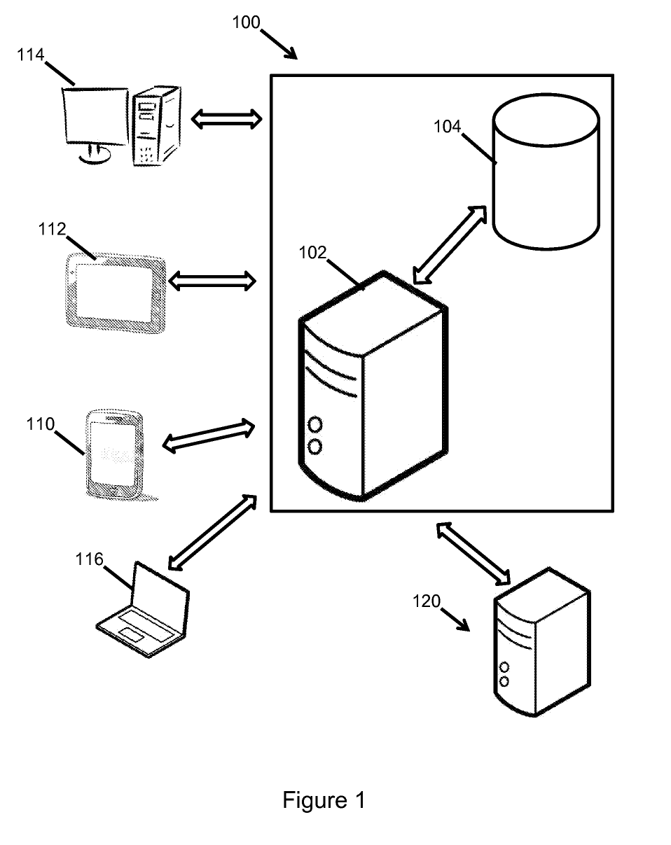

FIG. 1 illustrates a high-level overview of an exemplary CLDSS system 100 using a computing system 102. The computing system 102 can include one or more processors, memory devices and various other computing devices and/or peripherals. The various processors, memory devices, computing devices and/or peripherals can be accessible to one another over one or more networks. The CLDSS system 100 includes a medical knowledge database 104. The medical knowledge database 104 includes a list of tests developed and verified by experts in various fields including, for example, pathology, clinical medicine, laboratory medicine, infectious disease, etc. using peer-reviewed references such as journal articles, textbooks, lectures, etc. The medical knowledge database 104 also includes descriptive information regarding each test in the list of tests and this descriptive test information can be displayed to a user. A user can access the CLDSS system 100 using handheld devices 110, tablets 112, desktops 114, electronic health record (EHR) displays 116 and other electronic devices. The CLDSS system 100 can also be connected directly or remotely using a network to an electronic health record or other medical record system 120 to retrieve patient information.

A user can use the descriptive test information from the CLDSS system 100 to help confirm the appropriateness of a test order. The descriptive test information in the medical database 104 can be divided into sections for each test including Overview (detailed information regarding the use of the test), Indications (conditions in which the test is useful), Interpretation (conditions associated with an abnormal test result), Reference Ranges (limits outside of which a test is considered abnormal based on population studies), Specimen collection (how a specimen should be collected, stored and transported), Additional testing (tests that may provide additional information in addition to the chosen test) and References (peer-reviewed references with additional detailed information on how the test is used, verified, compared etc).

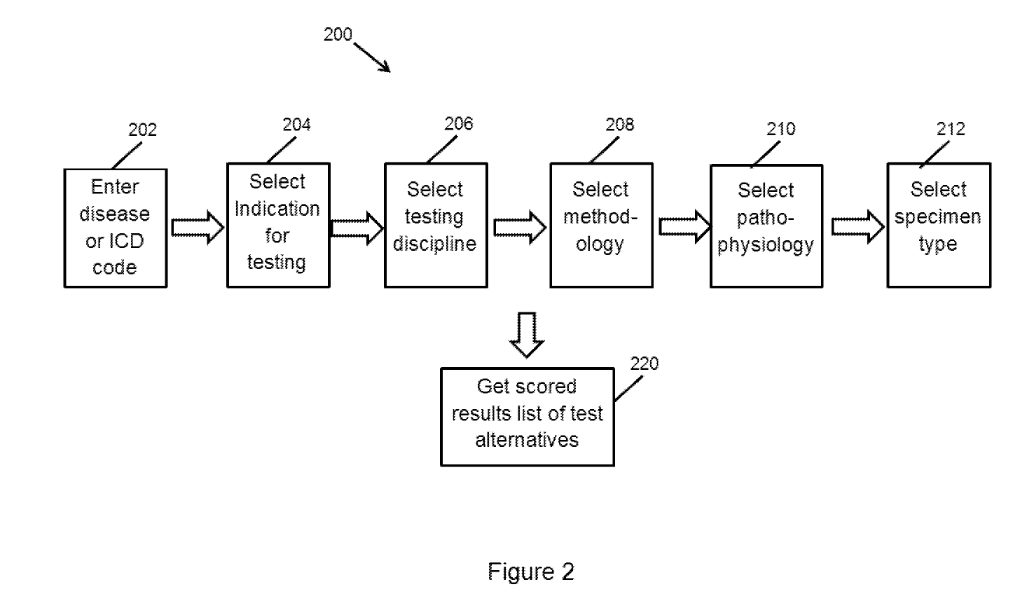

FIG. 2 shows an exemplary flow diagram 200 for an embodiment of a CLDSS system. At block 202, a user can enter or select a disease name or ICD-9 (International Classification of Disease, 9^{th} edition) code to identify a disease for which the user wants to determine an appropriate testing protocol. The ICD code is the standard disease code used by electronic healthcare record (EHR) systems. New versions of the ICD codes are released periodically, and the CLDSS system can utilize any appropriate version of the ICD codes. For each disease, the CLDSS system can include a list of relevant tests that have been sorted by degree of relevancy into relevancy categories. Many tests can be used for more than one disease, for example because they are not specific but test for changes common to many diseases, are screening tests, etc. The relevant tests can be displayed to the user in a ranking order based on various pertinent factors, for example, sensitivity, specificity, relevance, positive predictive value, negative predictive value, availability, medical necessity, etc. The CLDSS system then enables the user to select one or more filters to narrow down the test alternatives.

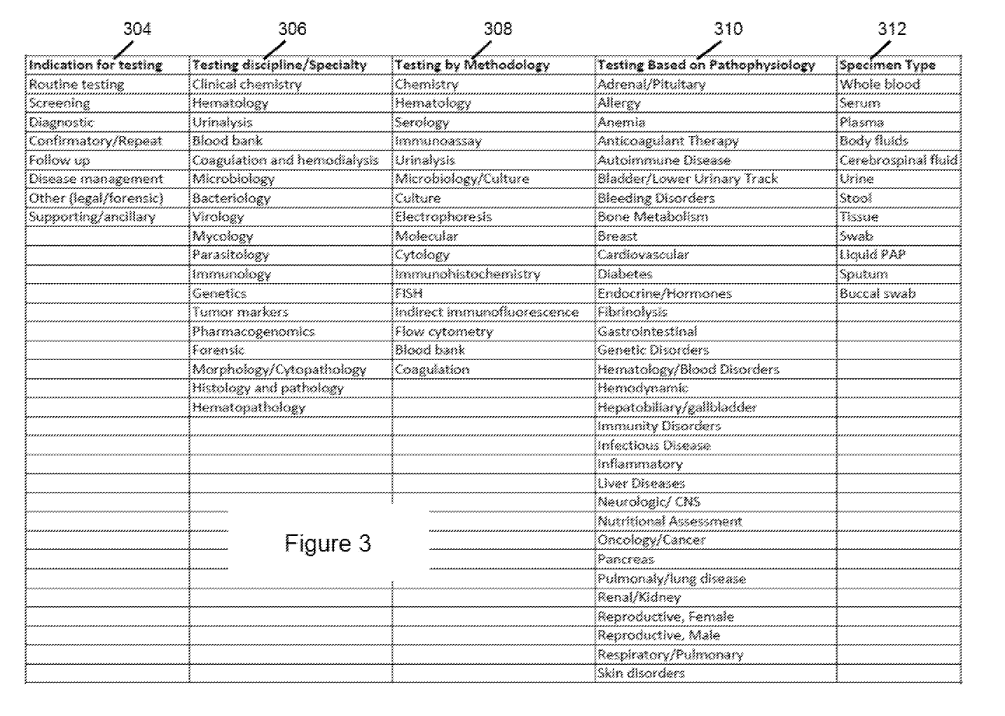

At step 204, the user can select an indication for testing to help filter the test alternatives. An exemplary set of indication for testing alternatives can include screening, routine, diagnostic, confirmatory, disease management, therapeutic monitoring, etc. An alternative set of indication for testing alternatives is shown in column 304 of FIG. 3. Each of the tests in the medical knowledge database 104 can include an associated indication for testing value and the user selection at step 204 can be used to weight the scoring of applicable tests. The CLDSS system can also display the available test alternatives to the user separated by indication for testing. For example, a list of screening tests, a list of routine tests, a list of diagnostic tests, etc. A test that fits into more than one category can be repeated in each category, for example in the list of screening tests and in the list of diagnostic tests.

At step 206, the user can select a testing discipline or medical specialty to help filter the test alternatives. An exemplary set of testing disciplines can include clinical chemistry, hematology, blood bank, immunology, genetics, cytopathology, histology, etc. An alternative set of testing discipline alternatives is shown in column 306 of FIG. 3. Each of the tests in the medical knowledge database 104 can include an associated testing discipline or medical specialty value and the user selection at step 206 can be used to determine applicable tests that fit within the user selected testing discipline or medical specialty. The CLDSS system can also display the available test alternatives to the user separated by testing discipline.

At step 208, the user can select testing methodology to help filter the test alternatives. An exemplary set of testing methodologies can include chemistry, hematology, molecular pathology, flow cytometry, cytology, coagulation, etc. An alternative set of testing methodology alternatives is shown in column 308 of FIG. 3. Each of the tests in the medical knowledge database 104 can include an associated testing methodology value and the user selection at step 208 can be used to determine applicable tests that fit within the user selected testing methodology. The CLDSS system can also display the available test alternatives to the user separated by testing methodology.

At step 210, the user can select pathophysiology to help filter the test alternatives. This enables the user to select tests based on body organ (for example, cardiovascular, pulmonary, skin, etc.) or based on disease category (for example, autoimmune, neoplasia, infectious disease etc.). A partial list for an alternative set of pathophysiology alternatives is shown in column 310 of FIG. 3. Each of the tests in the medical knowledge database 104 can include an associated pathophysiology value and the user selection at step 210 can be used to determine applicable tests that fit within the user selected pathophysiology. The CLDSS system can also display the available test alternatives to the user separated by pathophysiology.

At step 212, the user can select specimen type to help filter the test alternatives. An exemplary set of specimen types can include blood, urine, plasma, cerebrospinal fluid, tissue, stool, etc. A partial list for an alternative set of specimen type alternatives is shown in column 312 of FIG. 3. Each of the tests in the medical knowledge database 104 can include an associated specimen type value and the user selection at step 212 can be used to determine applicable tests that fit within the user selected specimen type. The CLDSS system can also display the available test alternatives to the user separated by specimen type.

At step 220, the CLDSS system applies any and all of the filters selected in steps 204-212 for the disease or ICD code entered at block 202 and generates a scored results list of test alternatives. The filter options and selection options described herein and shown in the Figures are intended to be exemplary and not limiting. Those of skill in the medical and healthcare areas will know of various other filter alternatives and selection alternatives that can be used in a CLDSS system. The user can select none, one or more of the filter options to narrow the list of test alternatives. The CLDSS system is intended to be flexible to accommodate the practitioner in terms of entering patient symptom data, suspected disease category, and other information. Any entered data or suspected disease can be further filtered by testing indication, medical necessity, methodology etc.

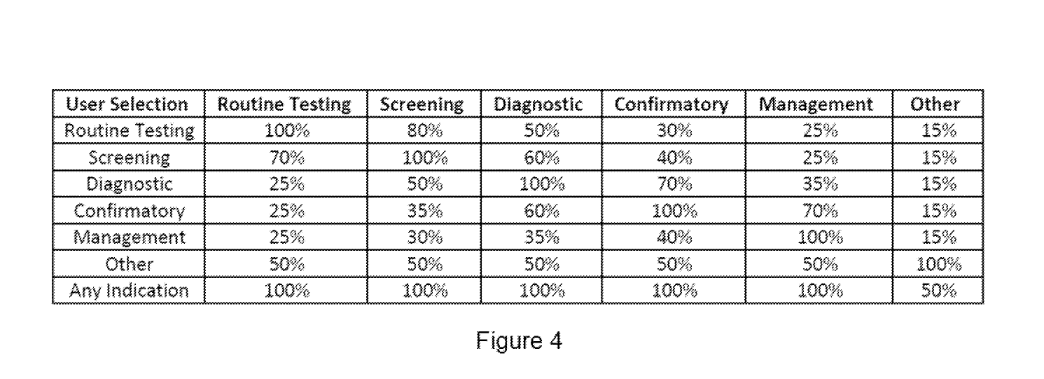

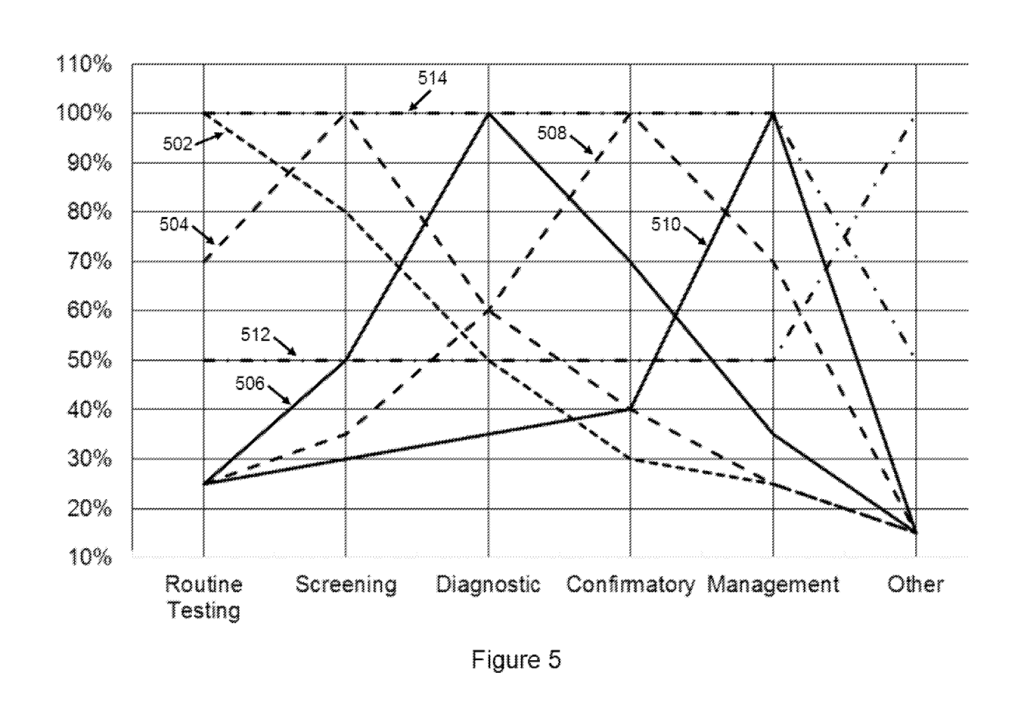

FIG. 4 shows an exemplary weighting scheme in tabular form for testing indication that can be used in a CLDSS system 100. FIG. 5 shows the same exemplary weighting scheme for testing indication in graphical form. In this embodiment of a CLDSS system 100, the set of testing indication alternatives includes: Routine Testing, Screening, Diagnostic, Confirmatory, Management, and Other. In FIG. 5, the testing indication weighting values for Routine Testing, Screening, Diagnostic, Confirmatory, Management, and Other are plotted on lines 502, 504, 506, 508, 510 and 512, respectively, and the testing indication weighting values when a testing indication is not selected are plotted on line 514.

In this embodiment of the CLDSS system 100, each of the tests in the medical knowledge database 104 includes an associated testing indication value. Then when the user selects a testing indication from the first column of FIG. 4 at block 204, a row of weighting values from FIG. 4 is determined; and any applicable tests from the medical knowledge database 104 are weighted by the weighting value in the column for the associated testing indication value of the applicable test. For example, using these values, if a user selected “Routine Testing” at block 204, then the CLDSS system would use a testing indication weighting value of 100%, 80%, 50%, 30%, 25%, and 15% for tests with an associated testing indication value of Routine Testing, Screening, Diagnostic, Confirmatory, Management, and Other, respectively. For example, using these values, if the user did not select any indication for testing value at block 204, then the CLDSS system would use a testing indication weighting value of 100%, 100%, 100%, 100%, 100%, and 50% for tests with associated testing indication value of Routine Testing, Screening, Diagnostic, Confirmatory, Management, and Other, respectively.

When a user has selected/entered a disease or ICD code at step 202 and selected the desired filters at steps 204-212, the CLDSS system 100 can search the tests in the medical knowledge database 104 to select applicable tests that fit the desired criteria of steps 206-212, and then, for each applicable test, apply a testing indication weighting value based on the selection at block 204 and the testing indication value for the applicable test. The CLDSS system 100 can then display the applicable tests and an associated score for each.

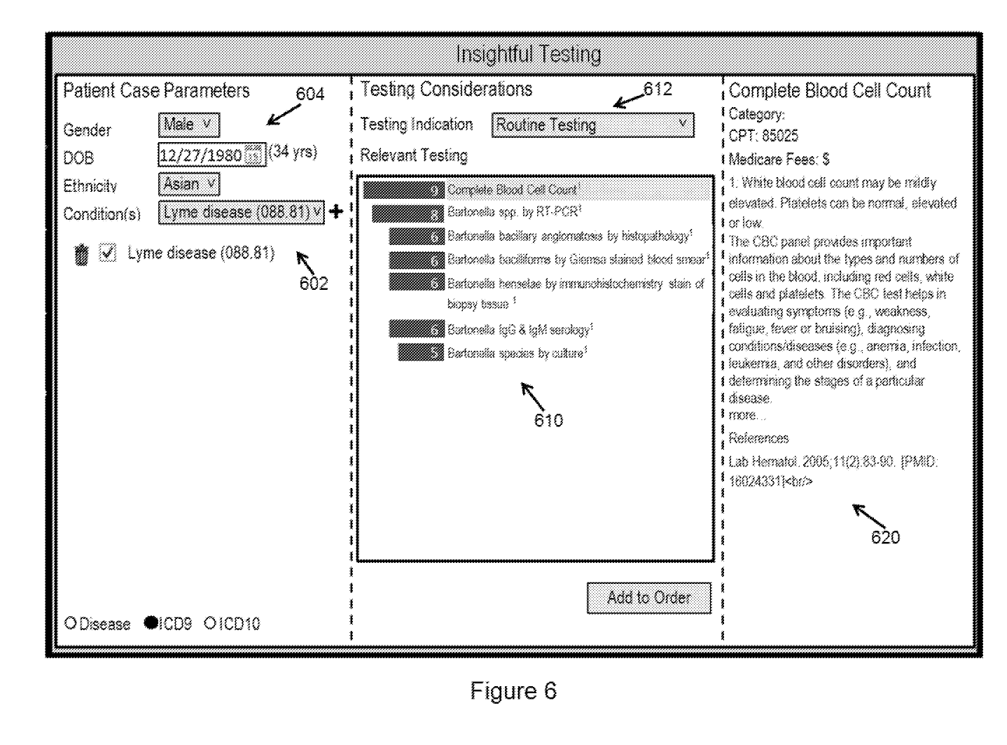

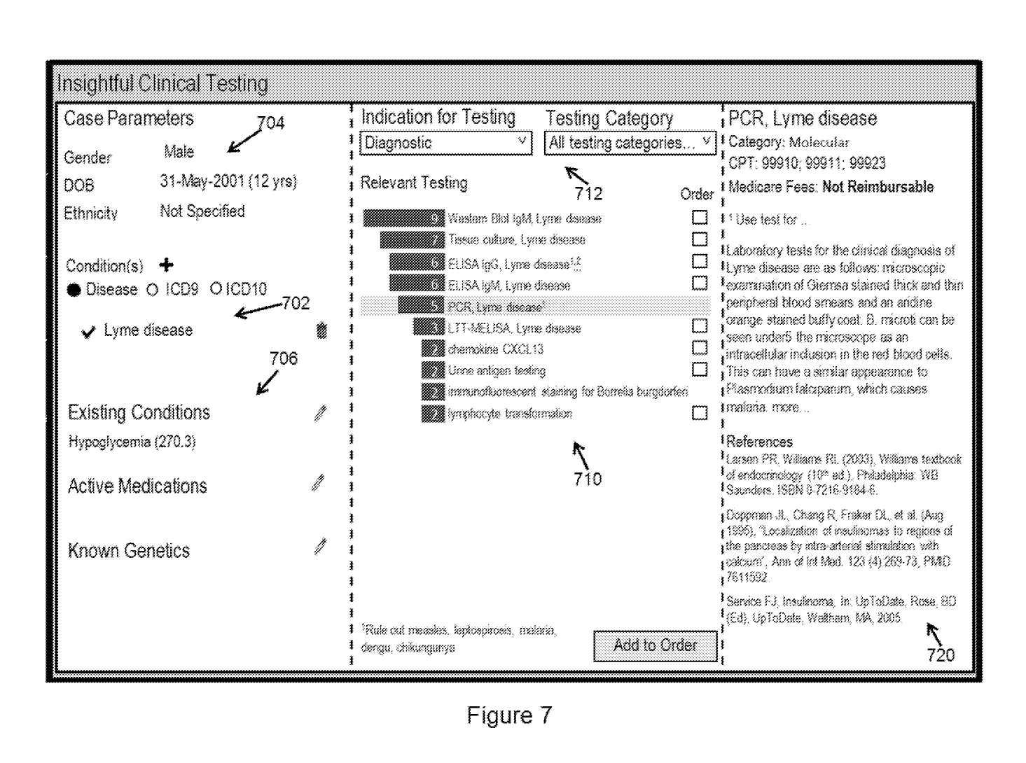

FIGS. 6 and 7 illustrate exemplary user interfaces for exemplary embodiments of a CLDSS system 100. When the system is initiated, a practitioner enters a suspected disease by name or category. Fields 602 and 702 show that the practitioner has entered Lyme disease. The practitioner can also enter patient information or link the CLDSS system 100 to the EHR for a specific patient. The CLDSS system 100 can retrieve demographic data as well as any additional pertinent patient data from the EHR system 120. This information entered by the user or retrieved from the EHR system 120 can include for example, gender, birth date, ethnicity, previously ordered tests, previous and existing conditions, medications, known genetics, etc. Fields 604, 704 and 706 show examples of this information entered by the user or retrieved from the EHR system 120.

The CLDSS system 100 takes the entered disease and patient information and generates a list of applicable tests derived from the medical knowledge base 104. The applicable tests can be chosen based on relevancy, accuracy, sensitivity, specificity, predictive value of a positive, precision, predictive value of a negative, availability, medical necessity, false discovery rate, false omission rate, true positive rate, false positive rate, true negative rate, positive likelihood ratio, negative likelihood ratio, diagnostic odds ratio, accuracy, prevalence in the population, F1-Score/F-score, Matthews correlation coefficient, markedness, informedness and other measures as researched and verified by experts. Sections 610 and 710 of FIGS. 6 and 7, show examples of the relevant tests found by the CLDSS system 100. The relevant tests are automatically ranked based on various pertinent factors, for example, sensitivity, specificity, precision, relevance, availability, etc. The ranking can include additional criteria, for example medical necessity, demographics, selected test indication, to sort the list of tests by relevancy. The CLDSS system 100 sorts the tests based on criteria entered previously by an expert and then also applies logic to place the tests on a test relevancy and/or proximity curve. This process can be performed within one disease for different test indications, for example, Screening, Diagnostic, Confirmatory, Therapy monitoring, Prognostication, etc. The list of relevant tests can be in the form of a series of horizontal bars of varying lengths and colors based on its relevancy as shown in FIGS. 6 and 7. The relevance ranking can score tests used for a diagnosis from 10 to 1 in decreasing order of relevance, and this can be represented visually to the user by a bar graph. The bar graph can use bar length, color and/or other visual indicators showing tests with the highest rank of one color and the colors progressively changing as the sort rank lowers.

The user can select one or more filters to narrow the list of relevant tests as described above. For example, FIG. 6 shows a testing indication filter 612, and FIG. 7 shows testing indication and testing category filters in section 712.

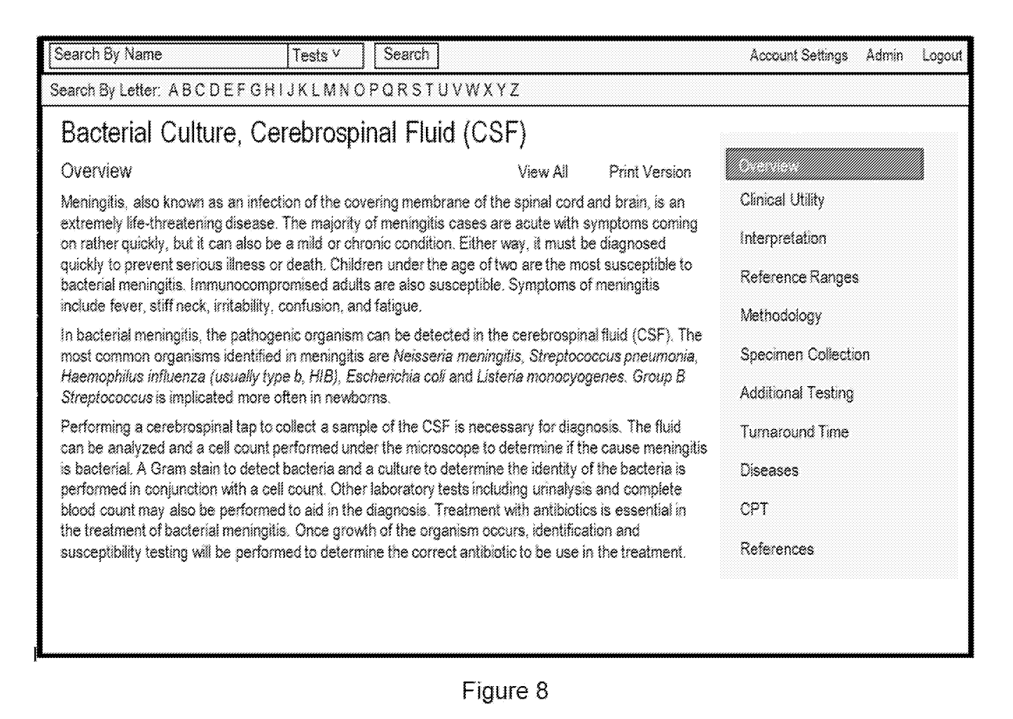

The CLDSS system 100 also enables the user to obtain more detailed information on the displayed information. For example, in FIG. 6 the user has clicked on the top ranked test, Complete Blood Cell Count, and section 620 shows a more detailed description of this test; and in FIG. 7 the user has clicked on the disease, Lyme disease, and section 720 shows a more detailed description of this disease. This detailed information can be stored on the medical knowledge database 104. This additional information helps the practitioner to verify the necessity of the test(s) before it is ordered. The user can also select even further more detailed information and the CLDSS system can provide a more in depth description of a disease, test or other relevant item. An example of this is shown in FIG. 8 as part of a searchable electronic medical dictionary.

The CLDSS system can help overcome overutilization of routine lab testing, underutilization of new test methodologies and skyrocketing medical costs. Using testing indication weighting values lowers the resulting score for routine tests that are performed over and over again. For example—most “screening” would involve a CBC or CBC with Differential test. Once the patient has gotten past “screening” and everything looks good, it is rare to have to keep doing CBC tests for diagnostic or confirmatory testing, yet this is often done. The scored list of testing alternatives from the CLDSS system will show that you can do a screening test again, but it is not as medically relevant as other more applicable tests. This will help reduce the amount of money spent on unnecessary routine testing which can also cause patient stress.

In some cases, the practitioner may not be aware of one or more of the most relevant tests. For example, if a Cerebrospinal fluid test by PCR for Encephalitis is the most relevant test but the doctor has never heard of this type of test, the CLDSS system will score this test highest and the doctor can click to the knowledge base and find out more information about the test.

If a highly relevant test is not covered by insurance, which many new tests are not, the CLDSS system can still score the test highly, but also alert the doctor that the test will not be paid for by CMS or the patient's insurance plan. The CLDSS system can then enable or prompt the doctor to find out more information on the test and why it is scored so high. The doctor can then use this information to inform the patient about the test and help the patient make an informed decision about whether they want the test to be done. The doctor can then petition the insurance carrier to pay for the test. The CLDSS system can also collect such information and use it to petition CMS and insurance carriers to add the test to “medical necessity” by proving good outcomes.

The CLDSS system can also display the expected costs along with the scores for relevant tests. Many studies have shown that if people know what different tests cost, they tend to select the lower cost test if it has the same clinical relevance. The CLDSS system can use the patient information available from accessible databases, for example the medical record system 120, to determine the expected cost for relevant tests using the insurance information for the particular patient.

The CLDSS system can be an assistive tool for decision-making and informational purposes. Thus, the system can be institutional with many users and interfaced with the EHR system, or it can be used by a single provider on various platforms including desktop, tablet, smartphone or other capable devices. Also, a decision support module can be embedded in the Medical Database product itself, so that the user can click on a disease while reviewing test information and bring up a list of all tests relevant to the original test and disease of interest. All tests, diseases and therapeutics can be clickable for more information. The workflow can then include all symptoms, signs, diseases, conditions, tests and therapeutics for a given disease or condition as well as diseases and conditions which could mimic the condition under primary consideration.

The CLDSS system can provide more than just a list of relevant tests for a selected disease. The CLDSS system can specifically and selectively score tests based on medical necessity, testing indication, test category, methodology and other parameters. The CLDSS system can list new tests that a practitioner is unfamiliar with and enable the practitioner to research the test and its relevancy using the CLDSS system. The scored results for the test alternatives can give the practitioner a precise test menu that can be used as a tool by practitioners for diagnosis and disease management. The CLDSS system can also provide coverage and cost information that can be used by the practitioner and/or the patient to make more informed healthcare decisions.

On the other side, insurance companies and other payers can use the CLDSS system for pre-approval of test or treatment plans, for review or pre-approval of expensive tests, for reviewing alternative tests, or for other applicable healthcare decisions. The CLDSS system can be used to help patients, healthcare providers, healthcare payers, and other involved entities to collaborate and reach decisions more effectively and efficiently.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A clinical laboratory decision support system comprising:
a medical knowledge database comprising a plurality of medical tests and relevance information for each of the plurality of medical tests;
a medical condition input for entering a medical condition;
a plurality of user-selectable filters for sorting relevant medical tests;
a processor that receives the medical condition and the plurality of user-selectable filters, accesses and searches the medical knowledge database for applicable tests from the plurality of medical tests, and sorts the applicable tests by relevance based on the medical condition, the plurality of user-selectable filters and the relevance information for each of the plurality of medical tests; and
an output device that presents the user with a sorted list of applicable tests by relevance as determined by the processor.

2. The clinical laboratory decision support system of claim 1, further comprising:
a hospital interface for retrieving patient information;
one or more patient identifiers for identifying a specific patient;
wherein the processor retrieves patient information through the hospital interface for the specific patient based on the patient identifiers, and also sorts the applicable tests by relevance based on the retrieved patient information.

3. The clinical laboratory decision support system of claim 1, wherein:
the relevance information for each of the plurality of medical tests includes an indication for testing value;
the plurality of user-selectable filters for ordering relevant medical tests includes an indication for testing filter selection; and
the processor also sorts the applicable tests by relevance based on the indication for testing values and the indication for testing filter selection.

4. The clinical laboratory decision support system of claim 1, wherein:
the relevance information for each of the plurality of medical tests includes a testing discipline value;
the plurality of user-selectable filters for ordering relevant medical tests includes a testing discipline filter selection; and
the processor also sorts the applicable tests by relevance based on the testing discipline values and the testing discipline filter selection.

5. The clinical laboratory decision support system of claim 1, wherein:
the relevance information for each of the plurality of medical tests includes a testing methodology value;
the plurality of user-selectable filters for ordering relevant medical tests includes a testing methodology filter selection; and
the processor also sorts the applicable tests by relevance based on the testing methodology values and the testing methodology filter selection.

6. The clinical laboratory decision support system of claim 1, wherein:
the relevance information for each of the plurality of medical tests includes a pathophysiology value;
the plurality of user-selectable filters for ordering relevant medical tests includes a pathophysiology filter selection; and
the processor also sorts the applicable tests by relevance based on the pathophysiology values and the pathophysiology filter selection.

7. The clinical laboratory decision support system of claim 1, wherein:
the relevance information for each of the plurality of medical tests includes a specimen type value;
the plurality of user-selectable filters for ordering relevant medical tests includes a specimen type filter selection; and
the processor also sorts the applicable tests by relevance based on the specimen type values and the specimen type filter selection.

8. The clinical laboratory decision support system of claim 1, wherein the sorted list of applicable tests includes a visual indicator for each of the applicable tests, the visual indicator for each of the applicable tests indicating a relevancy value for the applicable test.

9. The clinical laboratory decision support system of claim 1, wherein the sorted list of applicable tests includes payment information for each of the applicable tests; the payment information for each of the applicable tests indicating whether the applicable test is covered by patient insurance.

10. The clinical laboratory decision support system of claim 1, wherein the sorted list of applicable tests includes cost information for each of the applicable tests.

11. A clinical laboratory decision support method comprising:
accepting a medical condition input;
accepting one or more filter values from a plurality of user-selectable filter inputs;
searching a medical knowledge database for applicable tests based on the medical condition input and the one or more filter values, the medical knowledge database comprising a plurality of medical tests and relevance information for each of the plurality of medical tests;
sorting the applicable tests by relevance based on the medical condition input, the one or more filter values and the relevance information for each of the applicable tests; and
presenting the user with a sorted list of applicable tests by relevance.

12. The clinical laboratory decision support method of claim 11, further comprising:
accepting patient identification information for identifying a specific patient;
retrieving patient information from a healthcare database for the specific patient based on the patient identification information; and
also sorting the applicable tests by relevance based on the retrieved patient information.

13. The clinical laboratory decision support method of claim 11, wherein:
the relevance information for each of the plurality of medical tests includes an indication for testing value;
the plurality of user-selectable filters for ordering relevant medical tests includes an indication for testing filter selection; and
the method further comprises sorting the applicable tests by relevance based on the indication for testing values and the indication for testing filter selection.

14. The clinical laboratory decision support method of claim 11, wherein:
the relevance information for each of the plurality of medical tests includes a testing discipline value;
the plurality of user-selectable filters for ordering relevant medical tests includes a testing discipline filter selection; and
the method further comprises sorting the applicable tests by relevance based on the testing discipline values and the testing discipline filter selection.

15. The clinical laboratory decision support method of claim 11, wherein:
the relevance information for each of the plurality of medical tests includes a testing methodology value;
the plurality of user-selectable filters for ordering relevant medical tests includes a testing methodology filter selection; and
the method further comprises sorting the applicable tests by relevance based on the testing methodology values and the testing methodology filter selection.

16. The clinical laboratory decision support method of claim 11, wherein:
the relevance information for each of the plurality of medical tests includes a pathophysiology value;
the plurality of user-selectable filters for ordering relevant medical tests includes a pathophysiology filter selection; and
the method further comprises sorting the applicable tests by relevance based on the pathophysiology values and the pathophysiology filter selection.

17. The clinical laboratory decision support method of claim 11, wherein:
the relevance information for each of the plurality of medical tests includes a specimen type value;
the plurality of user-selectable filters for ordering relevant medical tests includes a specimen type filter selection; and
the method further comprises sorting the applicable tests by relevance based on the specimen type values and the specimen type filter selection.

18. The clinical laboratory decision support method of claim 11, further comprising:
displaying a visual indicator for each of the applicable tests, the visual indicator indicating a relevancy value for the applicable test.

19. The clinical laboratory decision support method of claim 11, further comprising:
accessing payment information for each of the applicable tests; and
displaying the payment information for each of the applicable tests, the payment information indicating whether the applicable test is covered by patient insurance.

20. The clinical laboratory decision support method of claim 11, further comprising:
accessing cost information for each of the applicable tests; and
displaying the cost information for each of the applicable tests.
